(19) United States
(12) Patent Application Publication
(10) Pub. No.: US 2003/0040356 A1
(43) Pub. Date: Feb. 27, 2003

(54) Credit card for use in amusement machines

(76) Inventor: Michael Gauselmann, Espelkamp (DE)

Correspondence Address: Brian D. Ogonowsky, Patent Law Group LLP, Suite 223, 2635 North First Street, San Jose, CA, 95134-2049, US

(21) Appl. No.: 10/142,335

(22) Filed: May 8, 2002

(30) Foreign Application Priority Data
Aug. 24, 2001 (DE) 101 41 659.8

(51) Int. Cl. A63F 13/00

(52) U.S. Cl. 463/20

(57) ABSTRACT

A reusable credit card, for use in a gaming machine, has a machine-readable code for generating credits in the gaming machine and a player-readable current value of the card printed on the card by the gaming machine. After a player finishes playing the gaming machine, the gaming machine prints the current value of the card, such as credits or a monetary value, on the card, then ejects the card so the player can use the card in the same or another gaming machine at a later time.

### FIELD OF INVENTION

The present invention relates to the use of credit cards, such as magnetic strip cards, bar coded cards, and smart cards, in amusement machines.

### BACKGROUND

From the publication DE OS 2803214, an amusement machine is known which comprises a read/write device for credit cards. When a credit card is inserted into the read/write device, the amusement machine checks if there is credit on the credit card. If there is credit on the card, the amusement machine is enabled for playing of a game. The number of credits is reduced (by a loss) or increased (by a win) each time a game is played. On a display device of the amusement machine, the user can see the extent of the credit on the credit card. A disadvantage of this invention is that the user of the amusement machine can only see the remaining credit when the card is inserted into the read/write device of the amusement machine. A further disadvantage is that the credits are stored on the credit card, which creates the risk of the credits being manipulated.

Furthermore, from the publication DE 196 23 590.C2, a device for a central account management of credit card operated game machines is known. In this system, the game machines are all connected to a central computer, which manages credit accounts. The game machines include a credit card reading device for reading account numbers. The central computer has a number of separate memory modules, each of which is assigned to an individual game machine connected to the central computer. Each module has a number of memory segments, which store account numbers and the value of each account. On insertion of a credit card, the credit value of the inserted card is determined by the central computer and sent to the game machine. The disadvantage of this system is that the credit value of the credit card is not shown to the player until the player inserts the credit card into a game machine.

The present invention solves the problems mentioned above.

### SUMMARY

The current invention relates to a reusable credit card for use in an amusement machine. The card contains a machine-readable code and a player-readable display of the current value of the card. In one embodiment, the machine-readable code is an encoded account number that is associated with credit information stored in a central computer. A gaming machine reads the encoded account number from the credit card and transmits the number to the central computer. The central computer then transfers the credit information from the central computer to the gaming machine for playing a game.

After a player finishes playing the gaming machine, the gaming machine will print the current value of the card on the card itself (and update the machine-readable code if appropriate) and then eject the credit card. The gaming machine will also send updated credit information to the central computer. The card may later be used in the same or a different machine, which will update the player-readable card value before the card is ejected.

In another embodiment, the machine-readable code includes the credit value of the card.

### BRIEF DESCRIPTION OF THE DRAWINGS

FIG. 1 shows a gaming machine in accordance with one embodiment of the present invention.

FIG. 2 is a block diagram of the gaming machine of FIG. 1.

FIG. 3 shows a gaming system in accordance with one embodiment of the present invention.

FIG. 4 is a block diagram of one embodiment of a credit device that may be used with the present invention.

FIGS. 5a and 5b show embodiments of a credit card storing machine-readable information associated with credits and displaying a player-readable current credit card value.

### DETAILED DESCRIPTION

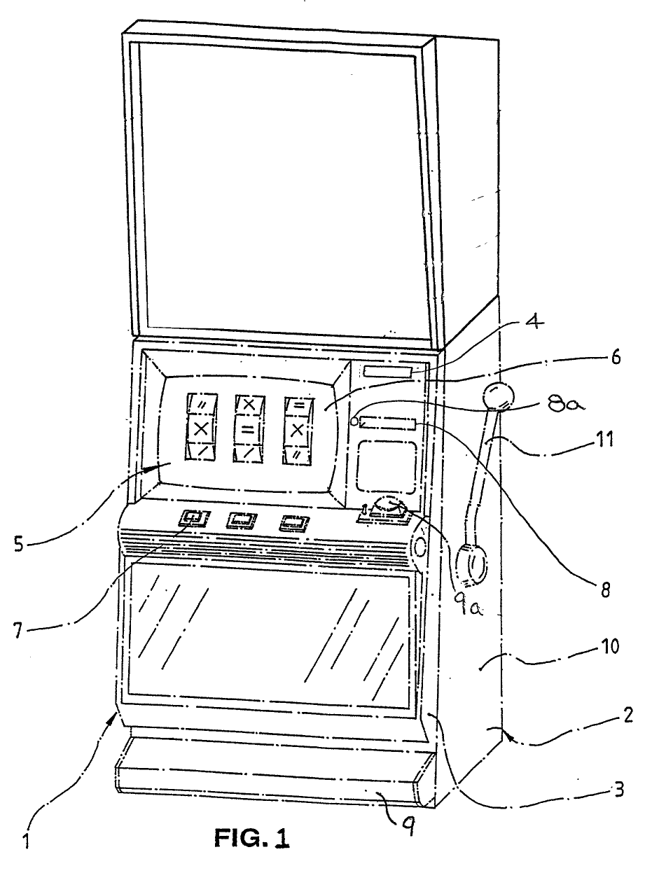

FIG. 1 shows a gaming machine 1 in accordance with one embodiment of the present invention. Gaming machine 1 comprises a housing 2 with a door 3 on the front. A credit counter 4 displays the credits available to a player for playing machine 1. There is an opening 5 through which a display 6 is visible. Display 6 may be a video display, physical reels, or any other type of display.

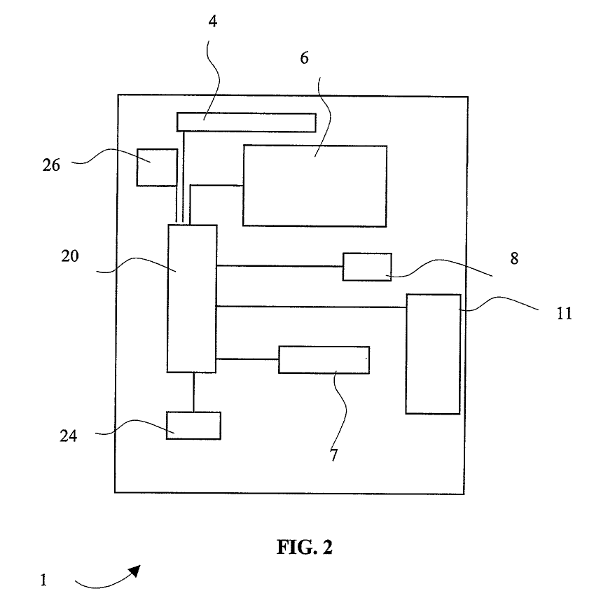

Below display 6 there are control elements 7, such as buttons, which are connected to a control unit 20 shown in FIG. 2. Control elements 7 may include a bet button, a spin reels button, and a cash out button, among others. At the lower part of housing 2, there is a coin tray 9, used if gaming machine I is equipped to handle both coins and credit cards. A coin input slot 9a receives coins. On a side 10 of housing 2, there is a control element 11 (a handle), which is also connected to control unit 20 (FIG. 2).

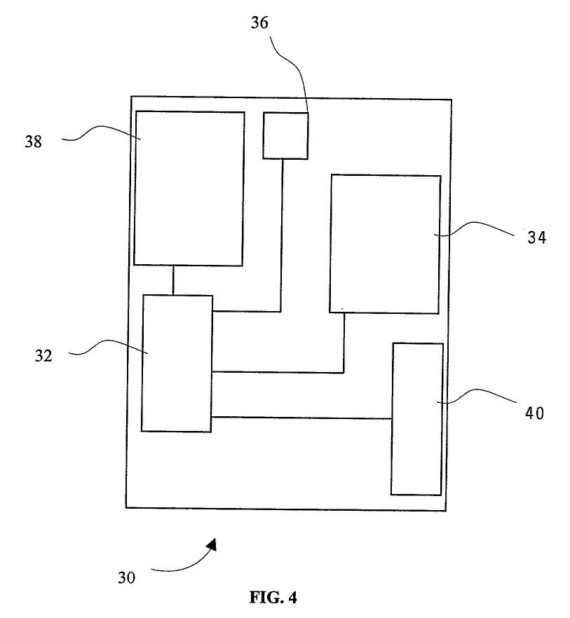

Gaming machine 1 also comprises a read/write card reader 8, which is connected to control unit 20 (FIG. 2). Read/write card reader 8 may comprise a bar code reader/writer (or other optical reader/writer), a magnetic strip reader/writer, a smart card reader/writer, or any other type of reader/writer that reads and writes a credit card code for generating credits in gaming device 1. Read/write card reader 8 for reading/writing machine readable code may use conventional techniques, and such read/write card readers are commercially available. Read/write card reader 8 may also comprises a control element 8a (a button) that allows a player to retrieve an inserted credit card. Alternatively, the card may be automatically ejected upon the player pressing a cash-out button. Additionally, read/write card reader 8 also comprises a printer for printing a player-readable value of the card, such as the number of remaining credits associated with the card or the monetary value of the card. Such a printer is discussed below with respect to FIG. 4.

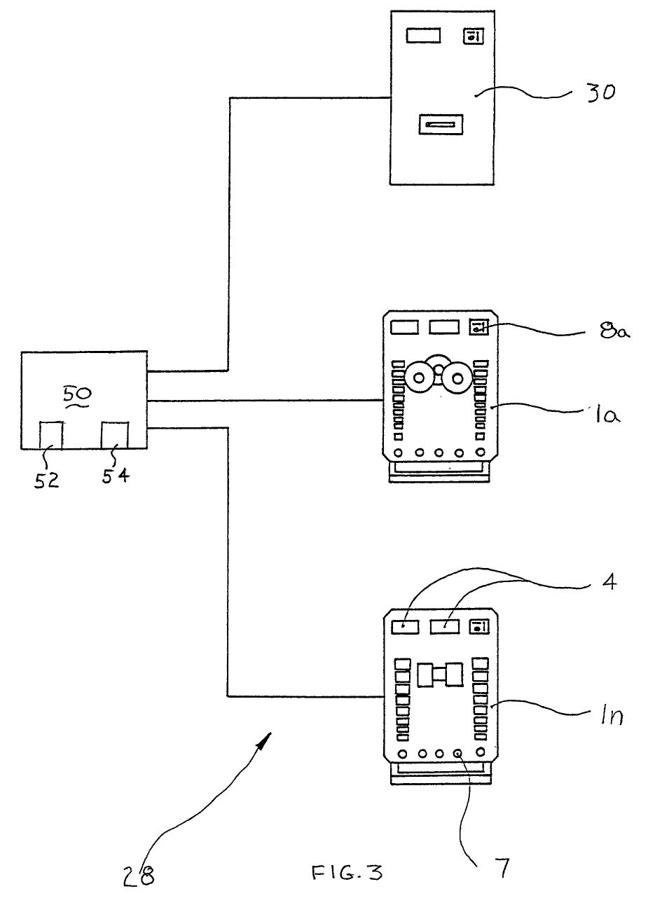

FIG. 2 is a block diagram of gaming machine 1 comprising a control unit 20. The block diagram shows credit counter 4, display 6, control elements 7, read/write card reader 8, and control element 11 connected to control unit 20. Moreover, gaming machine 1 comprises a memory device 24, which may store pay tables and game program data. Gaming machine 1 also comprises a communication device 26, which allows gaming machine 1 to be connected, either wirelessly or wired, with a central computer 50 (FIG. 3).

FIG. 3 shows a system of gaming machines 28 that may be used with the present invention. In an amusement arcade or casino, a plurality of machines 1a-1n may be connected wirelessly or via a wire to a central computer 50. Central computer 50 comprises a control unit 52 and a storage device 54. Central computer 50 performs various tasks including managing credit information for gaming system 28. Alternatively, each gaming machine 1a-1n operates autonomously.

Also shown in FIG. 3 is a credit device 30 for receiving payment from a player and for dispensing credit cards. Credit device 30 is connected to central computer 50 and transfers credit information to central computer 50. Alternately, each gaming machine 1a-1n can act as a credit device 30 by receiving cash and dispensing cards.

FIG. 4 is a block diagram of credit device 30. Credit device 30 comprises a control unit 32, which is connected to a money-handling device 34. Money-handling device 34 may comprise a bill acceptor and coin slot for input of currency by a player. Additionally, credit device 30 may also comprise a conventional credit/debit card reader 36 to allow a player to withdraw money from the player's bank account. A communication device 40 is also connected to control unit 32 for communication with central computer 50.

A card issue unit 38 is connected to control unit 32. Card issue unit 38 issues credit cards to players who insert money (or a monetary equivalent) into credit device 30, where such credit cards are used to play gaming machines in gaming system 28. Card issue unit 38 comprises an encoder, for encoding a machine readable account number or credit amount on the credit card, and a printer for printing the number of credits available for play on the issued credit card so the player knows the value of the card.

The credit card used in the present invention may be encoded and printed in different ways. In one embodiment, the cards are made of paper/cardboard or made of plastic, and the number of credit available for play are printed on them by a conventional ink jet printer, laser printer, or other type of printer. It should be understood that additional information may be printed or encoded on the card, if desired, such as the name of the gaming machine played, the location of the machine, and player information. An account number may be encoded on the credit cards using a magnetic strip, bar code, or smart card memory. Instead of an account number, or in addition to the account number, the credit amount may be encoded on the card for reading by card reader 8 (FIG.

Alternatively, the credit cards may comprise a special coating that allows erasable printing of the number of credits available for play, or erasable printing of the monetary value of the credit card. For example, a plastic card may be printed on using a thermochromatic card printer. A thermochromatic card printer erases previously printed information and allows the credit cards to be rewritable. The credit cards comprise a thermo-reversible coating that allows the credit information to be written or deleted by different temperatures. In this way, the previous credit information may be erased from the front of the card, and the updated credit information may be printed in the same location on the credit card. It should be understood that other card printers besides thermochromatic card printers may be used. Such thermochromatic card printers and the appropriately coated cards are available from Printherm, Z. I. d'Arrouet, 49170 St. Georges sur Loire, France. Other equivalent printers exist.

The credit cards can also be smart cards that contain active memory and processing elements to store account and/or credit information, where the current credit amount is printed on the card.

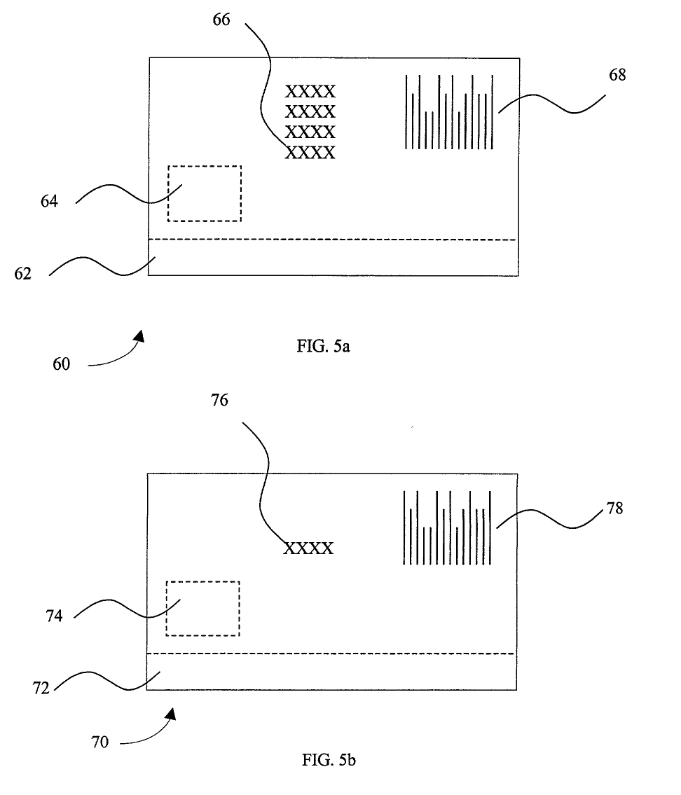

FIG. 5a shows a credit card 60 with a bar code 68 for encoding an account number. Alternatively, area 64 (shown in dotted lines) may comprise a smart card memory for storing account and/or credit information, or area 62 (also shown in dotted lines) may comprise a magnetic strip for encoding account and/or credit information. Credit card 60 also has the current credit value 66 of the card printed on it. In the embodiment of FIG. 5a, the current value of the card is printed below the previous value without erasing the previous credit value. A player may then look at the last value printed to determine the current number of credits available for playing a gaming machine. The printing may be performed by card reader 8 after the player presses the cashout button on the gaming device.

FIG. 5b shows a credit card 70 that is similar to card 60. Card 70 has a bar code 78 for encoding an account number. Card 70 may alternatively comprise a smart card memory device 74 or a magnetic strip 72 (both shown in dotted lines) for encoding account and/or credit information. Similar to card 60, card 70 has the current credit value 76 available for play printed on it. However, card 70 is rewritable so that previous credit values 76 may be erased and the current value printed in the same location. Credit card 70 may comprise a thermo-reversible coating that allows the credit card to be written or deleted with a thermochromatic printer.

Referring back to FIG. 3, in one embodiment when a player wishes to play one of gaming machines 1a-1n, a player inserts money into credit device 30, which is connected to central computer 50. Central computer 50 assigns an account number to the player's account and assigns a value to the account equal to the money inserted into credit device 30. Credit device 30 then issues the player a credit card encoded with the account number and printed with the credits available for play. Alternatively, only the credit information is encoded and printed on the card; however, this increases the likelihood of a player tampering with the card.

On insertion of the credit card into the read/write device 8 of a gaming device 1a-1n, the account number is read by the card reader 8 and sent to central computer 50. The value of the credit in the account is checked and sent to the requesting machine 1a-1n. A display 4 on gaming machine 1n-1a displays the number of credits available for play, and the gaming machine is enabled for playing a game.

The value of the credit stored in the gaming machine is reduced by the amount required to play the game machine 1a-1n, and the credits are increased in the case of a win. When the player is finished playing, the player presses a cashout button. Updated credit information is then sent to the central computer 50. The card reader 8 prints the new number of credits (or the monetary value) on the credit card. The gaming machine then returns the credit card to the player. The credit card may then be inserted into another gaming machine within gaming system 28, or reinserted into credit device 30 to add additional credit to the card. The read/write card reader 8 may comprise a separate path for the card reader portion and card printer portion.

In one embodiment, assuming the gaming machine does not accept coins or bills, if the player has run out of credits, the credit card is automatically ejected.

To avoid depleted credit cards remaining in a machine after a player has left the machine, the card may be ejected automatically after a period of non-use.

Thus, in accordance with the invention, the updated value associated with the reusable card is printed on the card. This allows a player the convenience of always knowing how much credit is available for game play without having to insert the credit card into a gaming machine.

The invention may be implemented by those skilled in the art using available hardware. Portions of the gaming machine not described in detail may be conventional.

While particular embodiments have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A reusable credit card for use in a gaming machine comprising:
a machine-readable code, for reading by said gaming machine, to generate credits to play said gaining machine; and
a printed, player-readable current value of said card, such that the same credit card may be used repeatedly in one or more gaming machines and display to a player a current value of said card after being ejected by said one or more gaming machines.

2. The credit card of claim 1 wherein said machine-readable code is an account number.

3. The credit card of claim 1 wherein said current value comprises a number of credits available.

4. The credit card of claim 1 wherein said current value comprises a monetary value of said card.

5. The credit card of claim 1 wherein said current value is printed with a thermochromatic printer.

6. The credit card of claim 1 wherein said credit card comprises a thermo-reversible coating which allows said current value to be rewritable.

7. The credit card of claim 1 wherein said credit card is a smart card.

8. The credit card of claim 1 wherein said credit card includes a magnetic strip.

9. The credit card of claim 1 wherein said credit card includes a bar code.

10. A gaming machine comprising:
a game display connected within said gaming machine for displaying a game; and
a credit card read/write device connected within said gaming machine for receiving reusable credit cards having a player-readable printed first card value and a machine-readable code, said read/write device comprising a reader for reading said machine-readable code on said credit cards for generating credits in said gaming machine, said read/write device also comprising a printer for receiving signals from said gaming machine and printing on a credit card a player-readable current value of said credit card prior to said credit card being ejected from said gaming machine.

11. The gaming machine of claim 10 wherein said machine-readable code is an encoded account number.

12. The gaming machine of claim 11 wherein said gaming machine is connected to a central computer which stores credit information associated with said account number.

13. The gaming machine of claim 12 wherein said central computer receives said account number from said gaming machine, and said gaming machine receives credit information from said central computer to enable play on said gaming machine.

14. The gaming machine of claim 13 wherein said central computer receives current credit information from said gaming machine, after a player finishes playing said gaming machine.

15. The gaming machine of claim 10 wherein said read/write device prints current credits on said credit card.

16. The gaming machine of claim 10 wherein said read/write device prints a current monetary value of said credit card on said credit card.

17. The gaming machine of claim 10 wherein said read/write device erases a previously printed card value and prints said current value.

18. The gaming machine of claim 10 wherein said read/write device prints said current value without erasing a previously printed card value.

19. The gaming machine of claim 10 wherein said credit card is a smart card.

20. The gaming machine of claim 10 wherein said credit card includes a magnetic strip.

21. The gaming machine of claim 10 wherein said credit card includes a bar code.

22. A gaming method comprising:
accepting a reusable credit card into a gaming machine, said credit card having a machine-readable code for generating credits in said gaming machine and having a player-readable first printed card value;
reading said machine-readable code to generate said credits in said gaming machine;
prior to said credit card being ejected by said gaming machine, printing a current card value on said credit card; and
ejecting said credit card.

23. The gaming method of claim 22 wherein said machine-readable code is an account number for accessing credit information.

24. The gaming method of claim 22 wherein said credit card is coated with a thermo-reversible coating for erasing previously print credit card values.

25. The gaming method of claim 22 wherein said printing comprises printing by a thermochromatic printer, said thermochromatic printer erasing any previously printed value before printing said current value.

26. The gaming method of claim 25 wherein said thermochromatic printer uses different temperatures for printing and erasing a current value.

27. The gaming method of claim 22 wherein said credit card is a smart card.

28. The gaming method of claim 22 wherein said credit card include a magnetic strip.

29. The gaming method of claim 22 wherein said credit card includes a barcode.

30. The gaming method of claim 22 further comprising, after ejecting said credit card, inserting said credit card into another gaming machine.
